(19) United States
(12) Patent Application Publication
(10) Pub. No.: US 2026/0189851 A1
(43) Pub. Date: Jul. 2, 2026

(54) AUDIO PLAYBACK SYSTEM

(71) Applicants: KAJIMA CORPORATION, Tokyo (JP); ADAPTIVE AUDIO LIMITED, Southampton, Hampshire (GB)

(72) Inventors: Motoki YAIRI, Tokyo (JP); Tsuguto HOSHINO, Tokyo (JP); Takashi TAKEUCHI, Winchester (GB); Philip Arthur NELSON, Hampshire (GB)

(21) Appl. No.: 19/129,649

(22) PCT Filed: Nov. 16, 2022
(86) PCT No.: PCT/JP2022/042618

§ 371 Date: May 13, 2025

(51) Int. Cl. H04R 3/14; H04R 5/02; H04S 3/00; H04S 7/00

(52) U.S. Cl. CPC H04R 3/14; H04R 5/02; H04S 3/008; H04S 7/302; H04S 2400/01; H04S 2400/05; H04S 2400/11

(57) ABSTRACT

A sound reproduction system includes a controller configured to reproduce three channels of sound from a plurality of speakers. The controller has an inversion unit configured to invert the polarity of either one of (i) an input signal for left speakers based on a left recording signal or (ii) an input signal for right speakers based on the left recording signal, and to invert the polarity of either one of (i) an input signal for right speakers based on a right recording signal or (ii) an input signal for left speakers based on the right recording signal, and a splitting unit configured to split the left recording signal and the right recording signal so as to form signals having discrete bandwidths. Either the plurality of speakers or the controller includes delay means for delaying, by a predetermined delay time for each speaker, the sound corresponding to the signals having the discrete bandwidths output from each left speaker and each right speaker. The delay time is set in advance for each left speaker and each right speaker so that crosstalk is canceled at a predetermined frequency.

### TECHNICAL FIELD

The present disclosure relates to a sound reproduction system.

### BACKGROUND ART

Patent Document 1 discloses a sound reproduction system that can reproduce the direction, distance, breadth and the like of sound in a three-dimensional manner. The system reproduces three channels of sound including a center channel, a left channel, and a right channel from a plurality of speakers, based on a left recording signal corresponding to the left ear of a listener and a right recording signal corresponding to the right ear of the listener. The system includes a center speaker corresponding to the center channel, a plurality of left speakers corresponding to the left channel, and a plurality of right speakers corresponding to the right channel. For each of the left speakers and for each of the right speakers, the system determines the frequency band of the sound that can be output, and distributes an appropriate frequency band signal to an appropriate speaker. The system forms filters for each speaker so as to cancel crosstalk. Crosstalk is a component of the sound that reaches the ear other than the one intended for control. Specifically, the system measures all transfer characteristics of the plant matrix from the speakers to both ears, and achieves binaural independent control by computing an inverse matrix (inverse system).

### CITATION LIST

### Patent Document

[Patent Document 1] Japanese Unexamined Patent Application Publication (Translation of PCT Application) No. 2010-532614.

### SUMMARY OF INVENTION

### Technical Problem

Because the system described in Patent Document 1 constructs and controls an inverse system strictly for all frequencies, detailed design through digital signal processing is required. Consequently, the system described in Patent Document 1 may cause an increase in computational cost, where “computational cost” refers to the amount of processing effort, the number of tasks, complexity, and so forth. The present disclosure provides a technique for reducing the computational cost required for binaural independent control.

### Solution to Problem

A sound reproduction system according to one aspect of the present disclosure reproduces sound in a listening space where a listener is present. The sound reproduction system includes a plurality of speakers and a controller. The plurality of speakers is arranged in the listening space. Based on a left recording signal corresponding to the listener's left ear and a right recording signal corresponding to the listener's right ear, the controller causes three channels of sound including a center channel, a left channel, and a right channel to be reproduced from the plurality of speakers. The plurality of speakers includes a center speaker corresponding to the center channel, a plurality of left speakers corresponding to the left channel, and a plurality of right speakers corresponding to the right channel. Each of the plurality of left speakers and each of the plurality of right speakers has a set in advance frequency band so that each speaker can output sound in a different frequency band. The controller has an inversion unit and a splitting unit. The inversion unit inverts the polarity of either one of an input signal for the left speakers based on the left recording signal or an input signal for the right speakers based on the left recording signal, so that their phase difference becomes 180 degrees for all frequencies, and also inverts the polarity of either one of an input signal for the right speakers based on the right recording signal or an input signal for the left speakers based on the right recording signal, so that their phase difference becomes 180 degrees for all frequencies. The splitting unit splits the left recording signal and the right recording signal into signals each having a discrete bandwidth. The controller reproduces the sound corresponding to these discrete-bandwidth signals through the center speaker, as well as through the right and left speakers assigned to the corresponding bandwidth. Either the plurality of speakers or the controller includes delay means for delaying, for each of the left speakers and each of the right speakers, the sound corresponding to the signals having the discrete bandwidth by a relative delay time set in advance for each left speaker and each right speaker with respect to the center speaker. The delay time is set in advance for each left speaker and each right speaker so that crosstalk is canceled at a predetermined frequency included in the bandwidth assigned to each.

In three-channel reproduction for achieving binaural independent control, the following must be satisfied in the signal processing for one side's recording signal: for all frequencies, the phase difference between the signal of the left channel and the signal of the center channel, and the phase difference between the signal of the center channel and the signal of the right channel, each shifts by a prescribed value (for example, 90 degrees). Further, for all frequencies, the phase difference between the signal of the left channel and the signal of the right channel must be offset by a prescribed value (for example, 180 degrees). In this sound reproduction system, the aforementioned phase differences are realized approximately by the combination of delay time and polarity inversion.

In this sound reproduction system, each left speaker and each right speaker is given a relative delay time, with respect to the center speaker, in advance. The sound corresponding to the signals having discrete bandwidths and output from each left speaker and each right speaker is delayed speaker by speaker, by the relative delay time with respect to the center speaker, the delay time having been set in advance for each left speaker and each right speaker so that crosstalk is canceled at a predetermined frequency included in the respective bandwidth. With these delay times, the phase difference between the signal of the left channel and the signal of the center channel, and the phase difference between the signal of the center channel and the signal of the right channel, can each be processed so as to shift by a prescribed value (for example, 90 degrees) at a predetermined frequency included in each bandwidth. Moreover, as for the phase difference between the input signals for the left speakers and the right speakers that are based on the left recording signal, it is shifted by 180 degrees at a predetermined frequency in each bandwidth by inverting the polarity of either the input signal for the left speakers or the input signal for the right speakers, so that the polarities of these two input signals differ. Likewise, the polarity of either the input signal for the right speakers based on the right recording signal or the input signal for the left speakers based on the right recording signal is inverted so that the polarities differ from each other, thereby causing the phase difference to shift by 180 degrees at a predetermined frequency in each bandwidth.

Thus, rather than computing an inverse system for all frequencies, this sound reproduction system applies a time difference (a simple delay) between the sound of the center speaker and the sound of the left and right speakers, while inverting the polarity of (i) either the input signal for the left speakers or the input signal for the right speakers based on the left recording signal and (ii) either the input signal for the right speakers or the input signal for the left speakers based on the right recording signal, so that crosstalk is canceled at a representative frequency (a given frequency) within the frequency band assigned to each speaker. In other words, processing of a given frequency within a frequency band stands as a proxy for the processing of that entire frequency band assigned to the speaker. Accordingly, compared to the case of computing an inverse system for all frequencies, this sound reproduction system can greatly reduce computational cost, albeit with some reduction in the accuracy of crosstalk cancellation for frequencies that deviate from the representative frequency.

In one embodiment, the delay time may be set in advance for each left speaker and each right speaker so that, at the predetermined frequency, the phase difference between the sound of the left channel and the sound of the center channel is shifted by 90 degrees, and the phase difference between the center-channel sound and the right-channel sound is shifted by 90 degrees. In such a case, the sound reproduction system can process the phase differences between the signals of the left channel and the center channel, and between the signals of the center channel and the right channel, to shift by 90 degrees at the predetermined frequency included in each band.

In one embodiment, the delay means included in the controller may be a delay unit that delays the signals having discrete bandwidths via signal processing. In such a case, the sound reproduction system can introduce the time difference (simple delay) relative to the sound of the center speaker by means of signal processing.

In one embodiment, the delay time Δτ may be determined in advance for each left speaker and each right speaker so as to satisfy Δτ=(Δr·sin θ)/(2·c), where, in a coordinate system using as its origin the center point between both ears of the listener as viewed in plan, θ represents the angle between the line connecting either the right speaker or the left speaker and the origin and the line connecting the center speaker and the origin, Δr represents the equivalent distance between both ears, and c represents the speed of sound.

In one embodiment, the delay means included in the plurality of speakers may be realized by arranging the center speaker, the plurality of right speakers, and the plurality of left speakers so that the sound corresponding to the signals having the discrete bandwidths and arriving at the listener is delayed, for each right speaker and each left speaker, by the delay time set in advance for that speaker. In this configuration, the sound reproduction system can introduce a time difference (simple delay) relative to the sound of the center speaker on account of how each of the right speakers and each of the left speakers is positioned.

In one embodiment, the arrangement positions of each speaker may be determined so as to satisfy Δl=(Δr·sin θ)/2 in a coordinate system taking as an origin the center point between both ears of the listener as viewed in plan, where θ represents the angle between the line connecting either the right speaker or the left speaker and the origin and the line connecting the center speaker and the origin, Δr is the equivalent distance between both ears, c is the speed of sound, and Δl is the path difference between the right (or left) speaker and the center speaker.

### Advantageous Effects of Invention

According to the present disclosure, a technique is provided that can reduce the computational cost associated with the binaural independent control.

### BRIEF DESCRIPTION OF DRAWINGS

FIG. 1 is a schematic diagram illustrating an example of a sound reproduction system according to an embodiment.

FIG. 2 is a block diagram illustrating an example of the sound reproduction system according to an embodiment.

FIG. 3 is a block diagram illustrating binaural synthesis via loudspeakers using a three-channel inverse system.

FIG. 4 is a diagram illustrating the geometric relationship between a sound source and the listener.

FIG. 5 is a diagram explaining the definition of azimuth span.

FIG. 6 is a diagram explaining the concept of a pair of monopole sound sources whose azimuth angle varies continuously as a function of frequency.

FIG. 7 is a graph showing the relationship between azimuth span and frequency for a plurality of left speakers.

FIG. 8 is a diagram explaining binaural control in a three-channel sound reproduction system.

FIG. 9 is a schematic diagram illustrating an example of a modified sound reproduction system.

FIG. 10 is a block diagram illustrating an example of a modified sound reproduction system.

FIG. 11 is a result of simulation for the sound pressure distribution obtained by a sound reproduction system that achieves time delay through signal processing.

FIG. 12 is a result of simulation for the sound pressure distribution obtained by a sound reproduction system that achieves time delay via speaker arrangement.

### DESCRIPTION OF EMBODIMENTS

Hereinafter, an embodiment of the present disclosure is described with reference to the drawings. In the following description, identical or corresponding elements are denoted by the same reference numerals, and redundant explanations will not be repeated. The dimensional proportions in the drawings do not necessarily match those in the following description. The terms “upper,” “lower,” “left,” and “right” are based on the illustrated state for convenience.

### [Configuration of Sound Reproduction System]

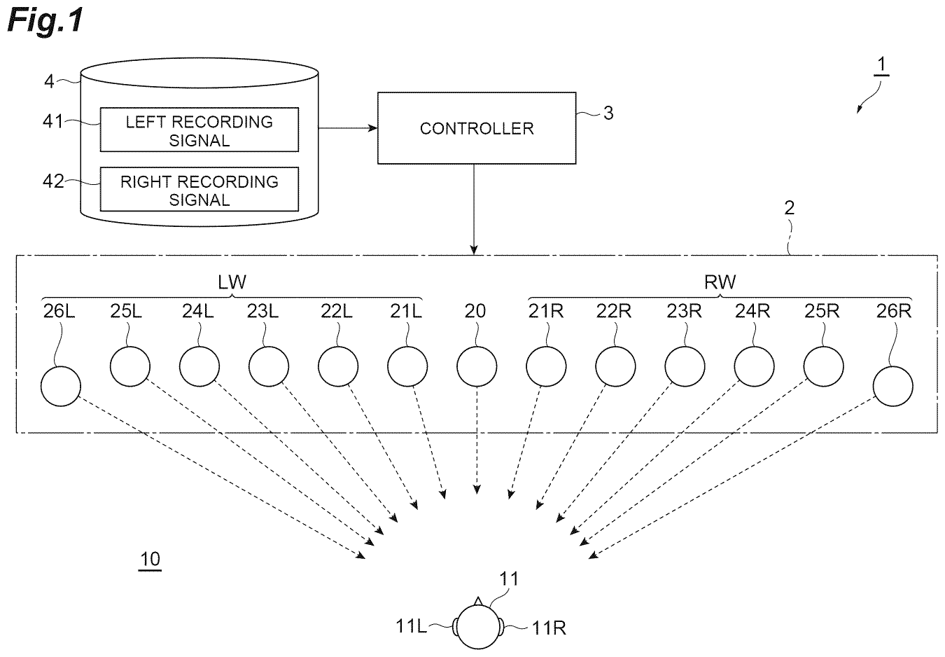

FIG. 1 is a schematic diagram illustrating an example of a sound reproduction system according to the embodiment. As shown in FIG. 1, a sound reproduction system 1 reproduces sound in a listening space 10 where a listener 11 is present. As shown in FIG. 1, the sound reproduction system 1 includes a multi-way speaker unit 2 (an example of a plurality of speakers), which is arranged in the listening space 10, and a controller 3.

The controller 3 is connected so as to be capable of controlling the multi-way speaker unit 2. The controller 3 may be configured as a computer system including, for example, a processor such as a CPU (Central Processing Unit), memory such as RAM (Random Access Memory) and ROM (Read Only Memory), input/output devices such as a touch panel, mouse, keyboard, and display, and a communication device such as a network card. In the controller 3, the processor controls each hardware component in accordance with a program stored in memory or the like, thereby providing the functionality of the controller 3 described below.

The controller 3 may be constructed to reference a database 4. The database 4 stores the sound to be provided to the listener 11. As one example, the database 4 stores a left recording signal 41 corresponding to the left ear 11L of the listener 11 and a right recording signal 42 corresponding to the right ear 11R of the listener 11.

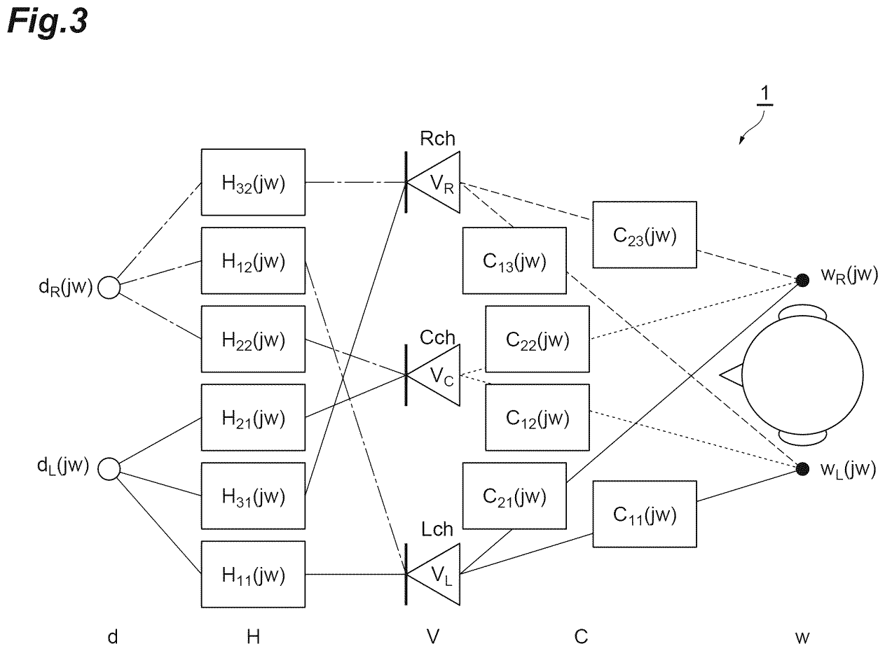

Based on the left recording signal 41 and the right recording signal 42, the controller 3 causes three channels of sound to be reproduced from the multi-way speaker unit 2. The three channels are a center channel Cch, a left channel Lch, and a right channel Rch, as will be described later with reference to FIG. 3. The multi-way speaker unit 2 includes a center speaker 20 corresponding to the center channel Cch, a plurality of left speakers LW corresponding to the left channel Lch, and a plurality of right speakers RW corresponding to the right channel Rch. The number of speakers corresponding to each channel is not limited in particular.

In the example shown in FIG. 1, the plurality of left speakers LW includes, sequentially from a position near the center speaker 20 to a position away from it, a first left speaker 21L, a second left speaker 22L, a third left speaker 23L, a fourth left speaker 24L, a fifth left speaker 25L, and a sixth left speaker 26L. Similarly, the plurality of right speakers RW includes, sequentially from a position near the center speaker 20 to a position away from it, a first right speaker 21R, a second right speaker 22R, a third right speaker 23R, a fourth right speaker 24R, a fifth right speaker 25R, and a sixth right speaker 26R.

Each of left speakers LW and each of right speakers RW is assigned a preset bandwidth such that each can output sound at different frequency ranges. For example, it is set in advance such that the farther a speaker is placed from the center speaker 20, the narrower the bandwidth of the output sound frequencies becomes. The center speaker 20 reproduces sound over the full range. This allows, for higher-frequency sound reproduced from the multi-way speaker unit 2, the center speaker 20 and those left and right speakers close to the center speaker 20 to output this sound. When a low-frequency sound is reproduced from the multi-way speaker unit 2, sound is output from the center speaker 20 and those left and right speakers positioned farther from the center speaker 20.

### [Details of the Controller]

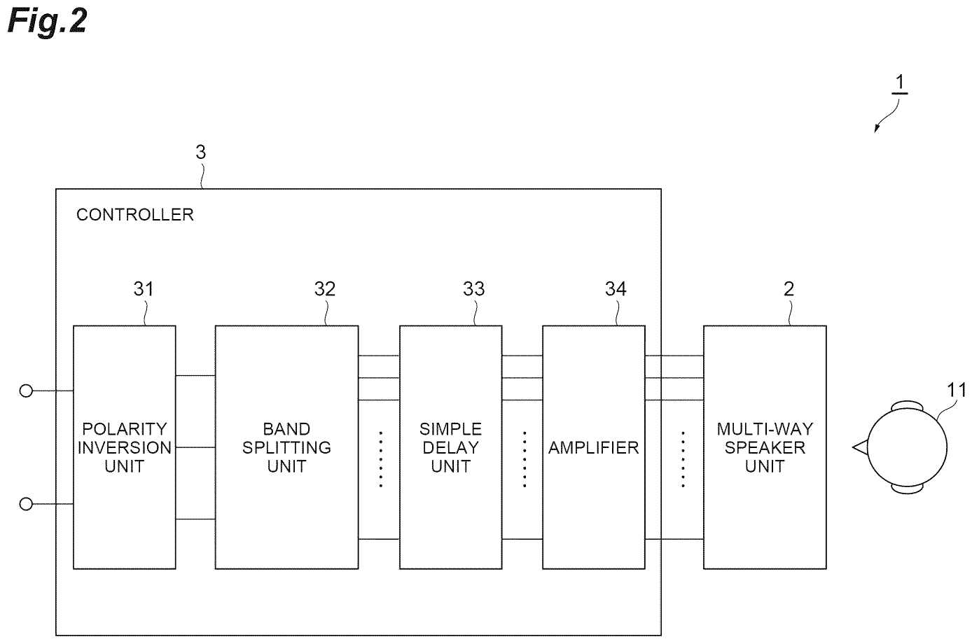

FIG. 2 is a block diagram illustrating an example of a sound reproduction system according to the embodiment. As shown in FIG. 2, the controller 3 includes input terminals that receive the left recording signal 41 and the right recording signal 42, and it is connected to the multi-way speaker unit 2. The controller 3 includes a polarity inversion unit 31 (an example of the inversion unit), a band splitting unit 32 (an example of the splitting unit), a simple delay unit 33 (an example of the delay means), and an amplifier 34.

The polarity inversion unit 31 inverts the polarity of either one of an input signal for the left speakers LW based on the left recording signal 41 or an input signal for the right speakers RW based on the left recording signal 41, so that the polarities of these two signals differ. The polarity inversion unit 31 similarly inverts the polarity of either one of an input signal for the right speakers RW based on the right recording signal 42 or an input signal for the left speakers LW based on the right recording signal 42, so that the polarities differ. By inverting the polarity, the phase difference between the signal of the left channel Lch and the signal of the right channel Rch is adjusted. As one specific example, when the input signal for the left speakers LW based on the left recording signal 41 takes a positive value, the polarity inversion unit 31 multiplies either the signal related to the left channel Lch or the signal related to the right channel Rch by a negative sign (−1) so that the input signal for the right speakers RW based on the left recording signal 41 will take a negative value.

The band splitting unit 32 splits the left recording signal 41 and the right recording signal 42 into separate frequency bands. As described above, each of the left speakers LW and each of the right speakers RW is assigned a preset bandwidth so that the bandwidths of the frequencies of the sound that can be output are different. Hereinafter, the signals resulting from the splitting performed by the band splitting unit 32 are referred to as “signals having discrete bandwidths,” which are allocated to and reproduced by the appropriate speakers that can output those bands.

The simple delay unit 33 delays, for each left speaker and each right speaker, the sound corresponding to the signals having the discrete bandwidths by a relative delay time that is set in advance for each left speaker and each right speaker, with respect to the center speaker. The delay time is set in advance for each left speaker and each right speaker so that crosstalk is canceled at a predetermined frequency included in the bandwidth assigned to each speaker. The simple delay unit 33 uniformly delays each signal by the same amount of time by speaker unit, i.e. for each corresponding bandwidth, via signal processing. The signal processing may be digital or analog. Details concerning the delay time will be described below.

The amplifier 34 amplifies the signal output from the controller 3 to the multi-way speaker unit 2. The multi-way speaker unit 2 converts the amplified signal into sound and provides it to the listener 11. Note that the polarity inversion unit 31 may be placed between the amplifier 34 and the multi-way speaker unit 2. In that case, the polarity inversion unit 31 may be implemented as a switch circuit that swaps the positive and negative terminal connections of either one of the left speaker or the right speaker.

### [Details of Binaural Independent Control]

To explain the binaural independent control by the controller 3, we first describe binaural synthesis over loudspeakers using a three-channel inverse system. FIG. 3 is a block diagram illustrating binaural synthesis over loudspeakers using a three-channel inverse system. As shown in FIG. 3, let d_{R}(jω) be the input signal for the right ear and d_{L}(jω) the input signal for the left ear, where ω is the angular frequency.

The inverse system is represented by an inverse filter matrix H, which processes these two input signals and produces signals for three channels including sound source V_{C} corresponding to the center channel Cch, sound source V_{R} corresponding to the right channel Rch, and sound source V_{L} corresponding to the left channel Lch. As one example, the inverse filter matrix H is a 2×3 matrix. Let the plant matrix C be the transfer matrix from each sound source to each of the listener's ears; as one example, C is also a 2×3 matrix. Let w_{R}(jω) be the signal received at the right ear, and w_{L}(jω) be the signal received at the left ear.

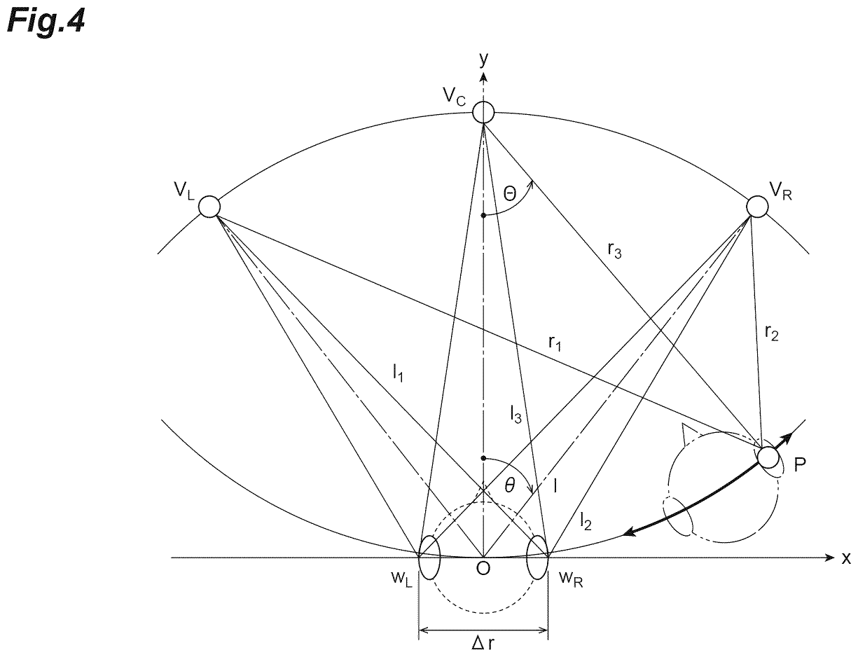

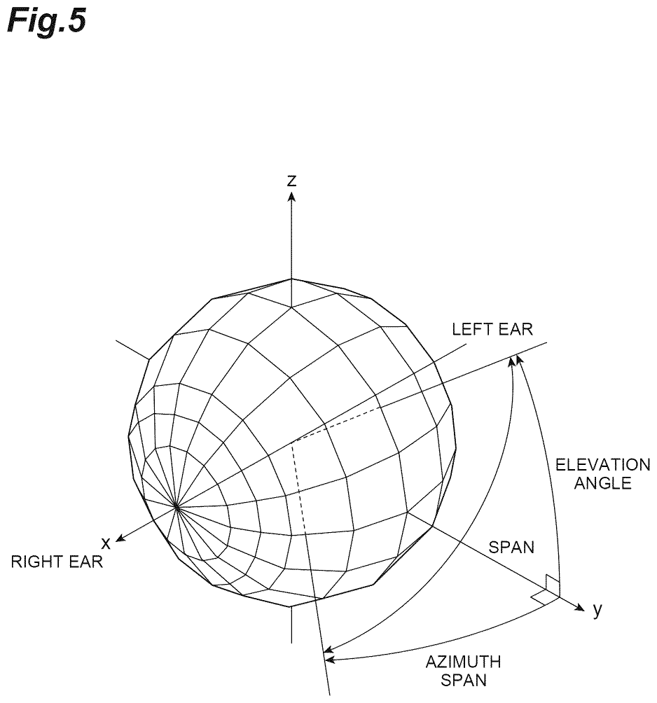

To describe the system shown in FIG. 3 mathematically, the positions of the sound sources and the listener 11 are defined as shown in FIGS. 4 and 5. FIG. 4 is a diagram illustrating the geometric relationship between a sound source and the listener, and FIG. 5 is a diagram explaining the definition of azimuth span. As shown in FIG. 4, the geometry of the sound sources and the listener is expressed in a coordinate system in which, as viewed in plan, the center point between the two ears of listener 11 is taken as the origin on the x-axis. Let an azimuth span θ be the angle formed by the line connecting either the sound source V_{L} or the sound source V_{R} and the origin and the line connecting sound source V_{C} and the origin. As shown in FIG. 5, the azimuth span θ is the difference between azimuth. The azimuth span θ is the opening angle from the perspective of the listener 11, between the sound source V_{C} and the lateral sound source V_{L} or V_{L}. Let Δr be the equivalent distance between the ears, which is the actual distance between the ears corrected for the diffraction around the head.

Under the positional relationship of FIGS. 4 and 5, the plant matrix C, normalized by the sound pressure at the left ear, is expressed in general by the following equation (1):

$$C = [ \begin{matrix}1 & g {e}^{- {j}^{\frac{1}{2}} {k}_{0} Δ r sin θ} & {e}^{- {jk}_{0} Δ r sin θ} \\ {e}^{- j {k}_{0} Δ r sin θ} & {ge}^{- {j}^{\frac{1}{2}} {k}_{0} Δ r sin θ} & 1\end{matrix} ] \qquad ( 1 )$$

where k₀=ω/c₀ (c₀ is the speed of sound), and g (>=0) is the relative sensitivity of the center channel Cch with respect to the left channel Lch and the right channel Rch. To simplify the physical interpretation of the inverse filter matrix, the effect of head-related transfer functions is not considered here; instead, it is treated as a symmetric problem under free-field conditions.

For ideal independent control of the two reception points (the right ear and the left ear), the inverse filter matrix H must satisfy the following relationship (2):

$$I = CH \qquad ( 2 )$$

where I is the identity matrix.

The maximum sound source strength (maximum amplification) needed to reproduce arbitrary input signals at any frequency can be obtained from the 2-norm ∥H∥ of the inverse filter matrix H, i.e., from its largest singular value, see equation (3) below:

$$‖ H ‖ = max ( {σ}_{i} , {σ}_{o} ) \qquad ( 3 )$$

where σᵢ and σₒ are the two singular values, corresponding to the amplification factor of the in-phase component and the out-of-phase component of the intended binaural signal, respectively. The singular values can be derived theoretically using singular value decomposition, as shown in equation (4):

$$[ \begin{matrix}{σ}_{i} = \frac{1}{\sqrt{( 1 + {e}^{- {jk}_{0} Δ r sin θ} ) ( 1 + {e}^{{jk}_{0} Δ r sin θ} ) + 2 {g}^{2}}} \\ {σ}_{o} = \frac{1}{\sqrt{( 1 - {e}^{- {jk}_{0} Δ r sin θ} ) ( 1 - {e}^{{jk}_{0} Δ r sin θ} )}}\end{matrix} \qquad ( 4 )$$

where g is the sensitivity. When singular values σᵢ and σₒ in equation (4) are re-expressed as functions of k₀·Δr·sin θ, singular values σᵢ and σₒ vary periodically and develop prominent peaks and valleys where the wave number k₀ and the azimuth span θ satisfy equation (5) for integer n:

$${k}_{0} Δ r sin θ = \frac{n π}{2} \qquad ( 5 )$$

This indicates that there is an optimal sound source position that can reproduce the in-phase component and out-of-phase component of a desired frequency with minimal effort. Where the two singular values σᵢ and σₒ become equal (σᵢ=σₒ), the frequency-azimuth relationship changes from n=1 (interaural path difference of ¼ wavelength) to n=3 (interaural path difference of ¾ wavelength) in equation (5). Hence, one could also utilize the relationship between frequency and azimuth when n=2 (interaural path difference of ½ wavelength), at which only the out-of-phase singular value σₒ alone becomes minimal.

In equation (5), at n=2, for the 2-norm of H to be minimized, equation (6) must be satisfied:

$$max ( {σ}_{i} ) = \frac{1}{\sqrt{2 {g}^{2}}} \leq min ( {σ}_{o} ) = \frac{1}{2} \qquad ( 6 )$$

That is, the sensitivity of the center channel Cch must be larger by a factor of \sqrt{2} compared to that of the left channel Lch and the right channel Rch, so that the inverse system can be configured with maximum efficiency (i.e., without excessive amplification). In this case, the inverse filter matrix H obtained from the minimum norm solution is given by equation (7):

$$H = \frac{1}{4} [ \begin{matrix}1 & - 1 \\ \sqrt{2} j & \sqrt{2} j \\ - 1 & 1\end{matrix} ] \qquad ( 7 )$$

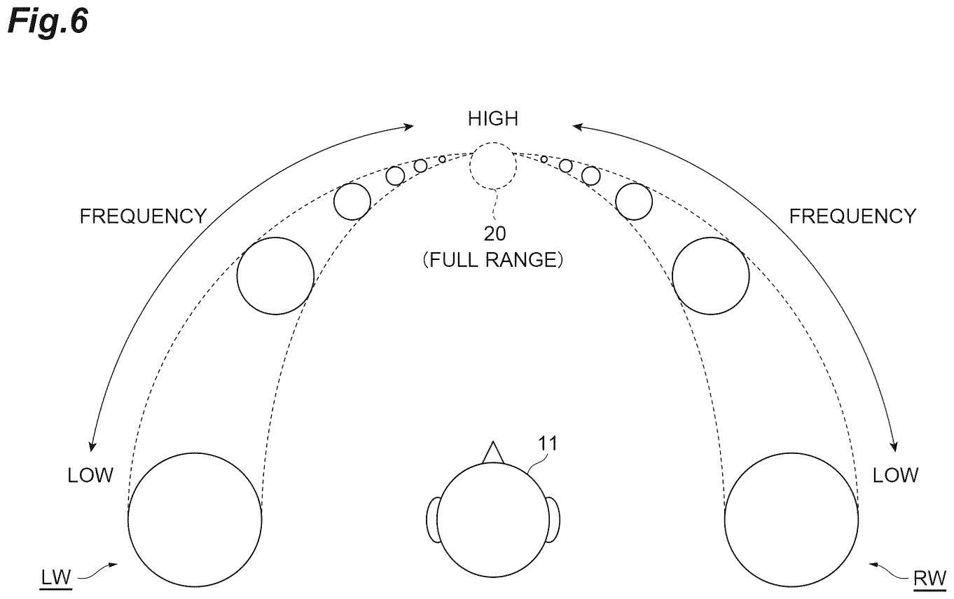

This means that, for two lateral sound sources contributing to the out-of-phase component to be canceled, the center channel that contributes to the in-phase component needs twice the sound source strength of each of the combined lateral sound sources. A conceptual monopole sound source that meets the principle of optimal sound source distribution for three channels is shown in FIG. 6. As shown in FIG. 6, it is a monopole sound source whose frequency and opening angle vary continuously with a fixed relationship so as to satisfy n=2 in equation (5).

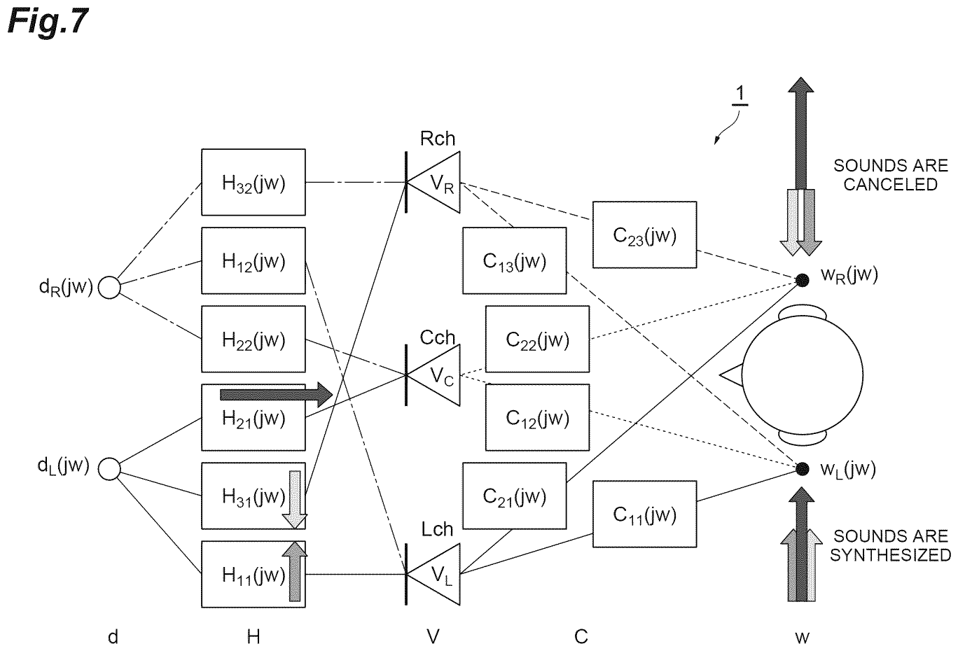

Focusing on the inverse filter matrix H in equation (7), shifting the phase of H₁₁ by 90 degrees gives H₂₁, and shifting the phase of H₂₁ by 90 degrees gives H₃₁. Also, inverting the polarity (i.e., shifting the phase by 180 degrees) of H₁₁ yields H₃₁. Based on these relationships, we briefly outline the binaural independent control according to the principle of optimal sound source distribution. FIG. 7 is a diagram explaining binaural control in a three-channel sound reproduction system. We first describe the case of providing the sound corresponding to the left recording signal 41 to the left ear of the listener.

As shown in FIG. 7, the left recording signal 41, denoted as d_{L}(jω), is branched into three channels by the inverse filter matrix H. The signal d_{L}(jω) is filtered by H₁₁(jω) as the signal corresponding to the left channel Lch and is then input to the sound source V_{L}. The sound from sound source V_{L} is delivered to the listener's left ear, and it also arrives at the listener's right ear with its phase rotated by 180 degrees. Meanwhile, d_{L}(jω) is filtered by H₃₁(jω) as the signal corresponding to the right channel Rch and is then input to the sound source V_{R}. The sound from the sound source V_{R} is delivered to the listener's right ear, and likewise arrives at the listener's left ear with its phase rotated by 180 degrees. Further, d_{L}(jω) is filtered by H₂₁(jω) as the signal corresponding to the center channel Cch and is then input to the sound source V_{C}. The sound from the sound source V_{C} is delivered to both ears in phase.

Accordingly, to satisfy equation (7), one may set H₁₁(jω)=¼, H₃₁(jω)=−¼, and H₂₁(jω)=(\sqrt{2}j)/4. In other words, when one has a monopole sound source that varies continuously in a fixed relationship between frequency and opening angle such that n=2 in equation (5), then complete inverse matrix system can be implemented simply by a delay operation and polarity inversion.

Next, let us consider the case of the discretized system. Take the optimal sound source position that allows minimal effort to reproduce the in-phase and out-of-phase components of the intended frequency, realized when n=2 in equation (5). We assume that this optimal sound source position is achieved by simply delaying, relative to the center sound source V_{C}, the sound from either V_{L} or V_{R}. Let the relative delay time be Δτ. Then equation (7) can be transformed into equation (8) below.

$$H = \frac{1}{4} [ \begin{matrix}1 & - 1 \\ \sqrt{2} {e}^{j Δ τ ω} & \sqrt{2} {e}^{j Δτω} \\ - 1 & 1\end{matrix} ] \qquad ( 8 )$$

Here, when Δτω=π/2 (i.e., 90 degrees), then equation (5) is satisfied. Substituting 2Δτω=π into n=2 in equation (5) gives equation (9):

$${k}_{0} Δ r sin θ = \frac{ω}{{c}_{0}} Δ r sin θ = π = 2 Δτω \qquad ( 9 )$$

Rearranging equation (9) in terms of the delay time Δτ yields equation (10):

$$Δτ = \frac{Δ r sin θ}{2 {c}_{0}} \qquad ( 10 )$$

By setting Δτ so as to satisfy equation (10), crosstalk is canceled at a predetermined frequency. In the graph in FIG. 7, for example, the intersections RP1 through RP6 of the n=2 plot and the assigned bands are determined as the predetermined frequencies mentioned above. In each frequency band, the delay time Δτ at that predetermined frequency is assigned as the delay time Δτ for that band, and the entire band uses that uniform delay time Δτ.

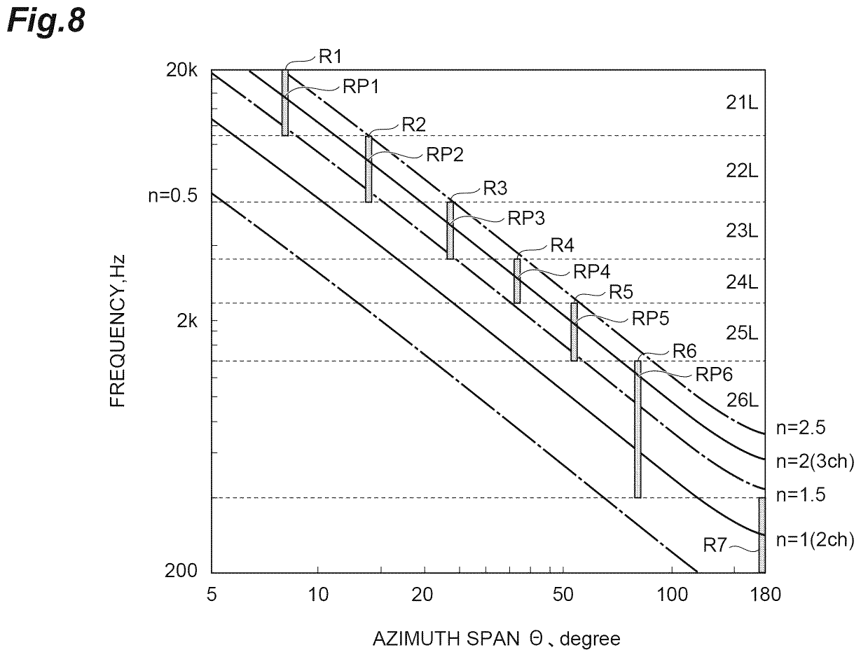

FIG. 8 is a graph showing the relationship between azimuth span and frequency for a plurality of left speakers. On the horizontal axis is the azimuth span, and on the vertical axis is the frequency. In FIG. 8, the plots of equation (5) for values n=0.5, 1, 1.5, 2, and 2.5 are shown. The case of n=1 corresponds to two channels, and the case of n=2 corresponds to three channels. As shown in FIG. 8, for frequency bands generally above about 2 kHz, each left speaker is allocated a frequency band such that n=1.5 is the lower limit and n=2.5 is the upper limit. In the example of FIG. 8, the first left speaker 21L is allocated a first band R1, the second left speaker 22L is allocated a second band R2, the third left speaker 23L is allocated a third band R3, the fourth left speaker 24L is allocated a fourth band R4, and the fifth left speaker 25L is allocated a fifth band R5. For frequencies generally below about 2 kHz, the sixth left speaker 26L is allocated a sixth band R6, which includes bands lower than n=1.5. A seventh band R7, even lower than the sixth band R6, may be allocated to, for example, a woofer (not illustrated).

### Summary of Embodiment

In the sound reproduction system 1, each left speaker and each right speaker are given in advance a relative delay time Δτ with respect to the center speaker 20. The sound corresponding to the signals having the discrete bandwidths and output from each left speaker and each right speaker is delayed speaker by speaker, by the relative delay time Δτ with respect to the center speaker 20, the relative delay time Δτ being set in advance for each left speaker and right speaker so that crosstalk is canceled at a predetermined frequency included in the bandwidth of each left speaker and right speaker. By setting such a delay time, the phase difference between the signal of the left channel Lch and the signal of the center channel Cch and the phase difference between the signal of the center channel Cch and the signal of the right channel Rch are each processed so as to shift by 90 degrees at a predetermined frequency included in each band. Further, for the phase difference between the signal of the left channel Lch and the signal of the right channel Rch, the input signals to the left and right speakers that are based on the left recording signal 41 are polarity-inverted relative to each other, and the input signals to the right and left speakers that are based on the right recording signal 42 are also polarity-inverted relative to each other. As a result, the phase difference is processed so as to shift by 180 degrees at the predetermined frequency in each band.

Thus, rather than computing an inverse system for all frequencies, the sound reproduction system 1 applies a time difference (simple delay) between the sound of the center speaker and the sound of the left and right speakers, while inverting the polarity of either one of the left speaker's or right speaker's sound signals so that crosstalk is canceled at a representative frequency (a predetermined frequency) in the frequency band assigned to each speaker. Put differently, calculation for that predetermined frequency in each band effectively stands in for the calculation across the speaker-assigned frequency band. Accordingly, compared to the case of computing an inverse system for all frequencies, the sound reproduction system 1 can significantly reduce computational cost, even though the accuracy of crosstalk cancellation at frequencies away from the representative frequency will be somewhat lowered.

### [Modifications]

While various exemplary embodiments have been described above, they are not limited thereto; a variety of omissions, substitutions, and changes may be made as appropriate.

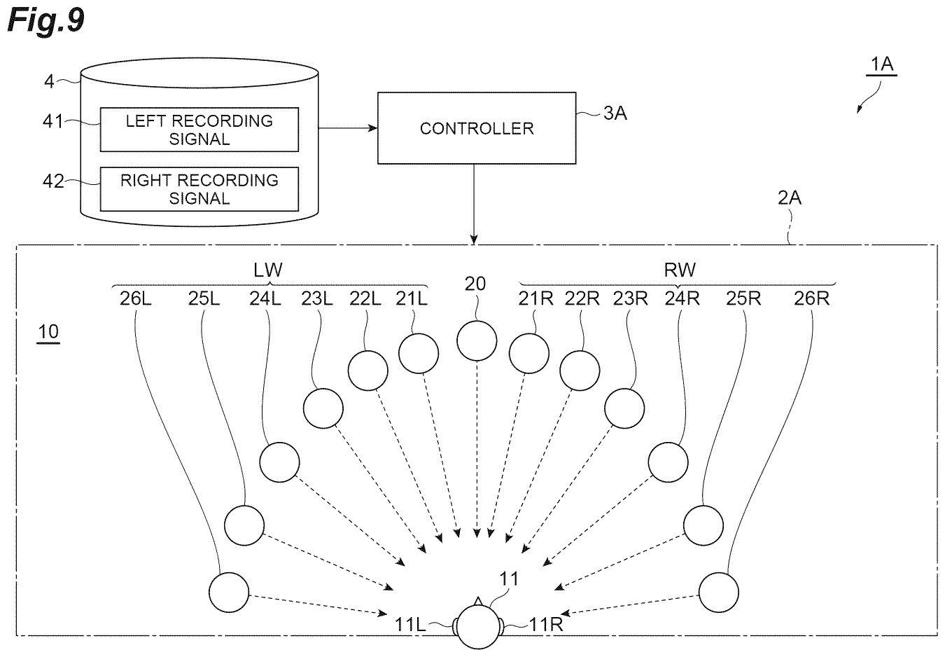

In the above embodiment, “delay means” is provided in the controller 3, but the delay means could also be realized via the arrangement of the plurality of speakers. FIG. 9 is a schematic diagram illustrating an example of a modified sound reproduction system. The sound reproduction system 1A differs from the sound reproduction system 1 in that it includes a multi-way speaker unit 2A with a different speaker arrangement and a controller 3A having no delay means. Other aspects remain the same. The following describes mainly the differences from the sound reproduction system 1, omitting redundant explanations.

As shown in FIG. 9, the multi-way speaker unit 2A, similar to the multi-way speaker unit 2, includes a center speaker 20 corresponding to the center channel Cch, a plurality of left speakers LW corresponding to the left channel Lch, and a plurality of right speakers RW corresponding to the right channel Rch. The number of speakers corresponding to each channel is not limited in particular.

The center speaker 20, the right speakers RW, and the left speakers LW are arranged so that the sound corresponding to the signals having the discrete bandwidths and arriving at the listener 11 is delayed speaker by speaker, by the delay time Δτ set in advance for each of the right speakers and left speakers. In other words, distances between the speakers and the listener 11 are adjusted in advance so that the sound output by the left and right speakers arrives with a relative delay time Δτ compared to the center speaker 20. Using the speed of sound c₀, the delay time Δτ indicated in equation (10) may be converted into a path difference Δl:

$$Δ l = Δτ {c}_{0} = \frac{Δ r sin θ}{2} \qquad ( 11 )$$

The path difference Δl is the difference between the path l₃ from the center speaker 20 to the listener 11 and the path l₁ from the left (or right) speaker to the listener 11. In this way, each speaker can be arranged in advance so as to satisfy the delay time Δτ.

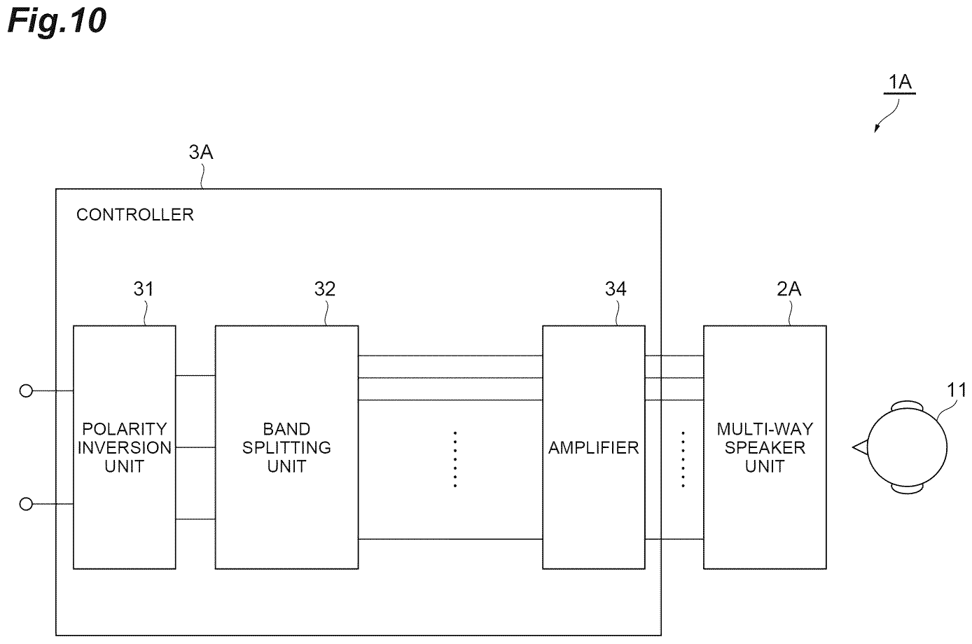

FIG. 10 is a block diagram illustrating an example of a modified sound reproduction system. The controller 3A shown in FIG. 10 differs from the controller 3 in that it does not have the simple delay unit 33. In other respects, it is the same.

Further, the numbers of right speakers and left speakers explained in the above embodiment may be altered as appropriate. The number of right speakers does not have to match the number of left speakers. Also, at least one center speaker 20 is sufficient; in other words, another center speaker could be added. The center speaker 20 and any additional center speaker would be arranged in the median plane of the listener 11. When the sound reproduction system has the center speaker 20 plus another center speaker, the center speaker 20 need not reproduce full-range sound; rather, each may reproduce the sound for the frequency region assigned to that speaker, and the multiple center speakers may collectively reproduce the overall full-range sound.

In the above embodiment, the allocation of speaker frequency bands was described such that n=1.5 and n=2.5 define the lower and upper limits, respectively. However, the numeric values of n that define the frequency bands are not limited to these; they may be set as appropriate, provided the lower limit is an n smaller than 2 and the upper limit is an n larger than 2. For instance, frequency bands could be defined so that n=1 is the lower limit and n=3 is the upper limit.

Above, the intersections RP1 through RP6 between the plot for n=2 in FIG. 7 and the assigned frequency bands were cited as the representative frequencies of the discrete bandwidths, but the selection of those representative frequencies is not limited to that example. The representative frequency in each bandwidth may be chosen as appropriate.

### Example

An example implemented by the present inventors is described below to demonstrate the above effects.

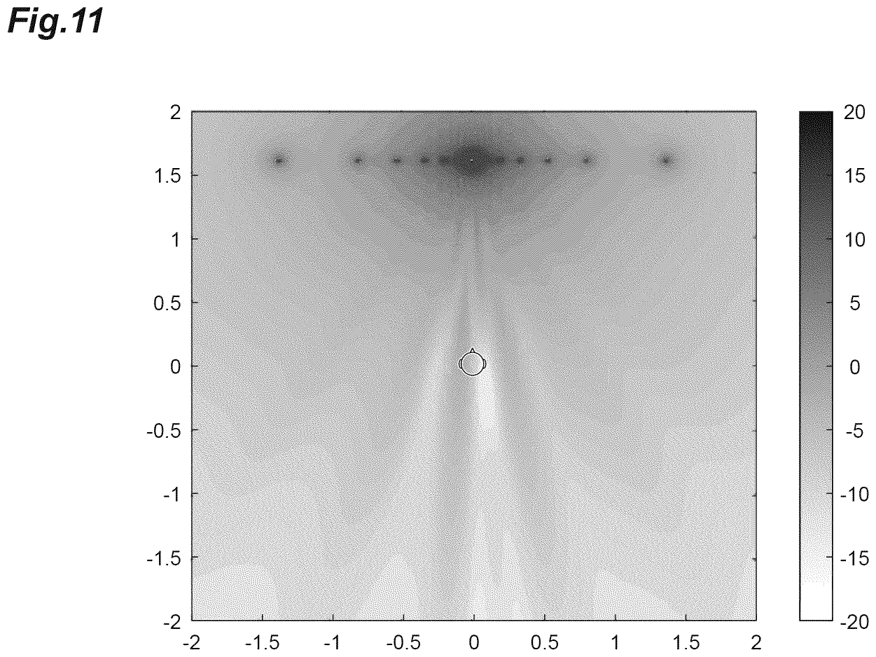

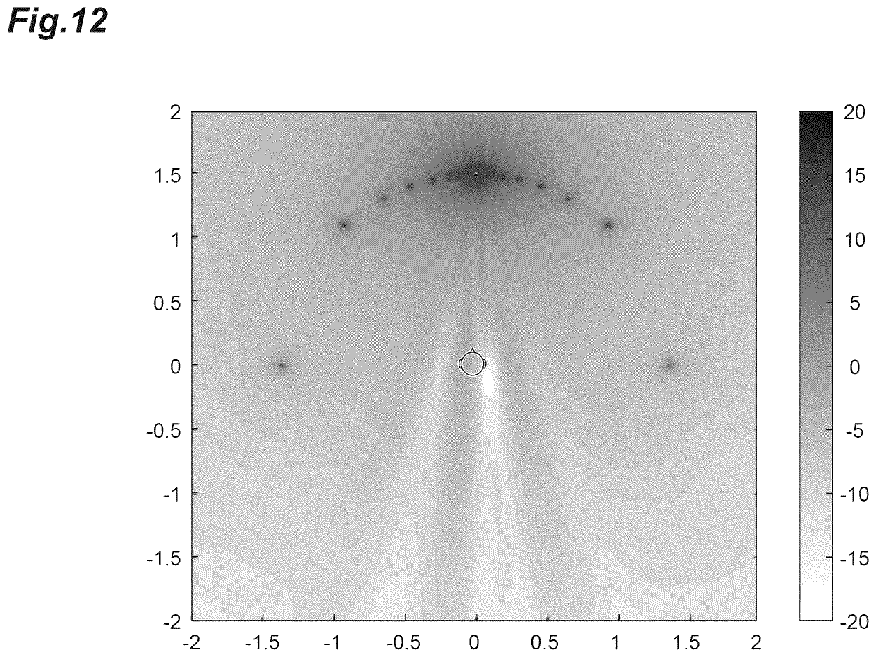

They used the sound reproduction systems 1 and 1A shown in FIGS. 1 and 9, respectively, and assumed the listener 11 was at the origin in the listening space 10, then performed a simulation of the sound pressure distribution. FIG. 11 shows the result for the sound reproduction system 1, and FIG. 12 shows the result for the sound reproduction system 1A.

FIG. 11 is the simulation result of the sound pressure distribution by the sound reproduction system that achieves time delay via signal processing. FIG. 12 is the simulation result of the sound pressure distribution by the sound reproduction system that achieves time delay via speaker arrangement. Both FIGS. 11 and 12 depict the sound pressure level (dB) by shading. As shown in FIGS. 11 and 12, in both distributions, the left ear of the listener 11 is about 0 dB, whereas the right ear is around −20 dB, which verifies that sufficient attenuation is achieved at the right ear. This confirms that binaural independent control can be realized by polarity inversion and time delay. It also confirms that the time delay may be implemented by signal processing or by speaker arrangement.

### REFERENCE SIGNS LIST

1, 1A . . . sound reproduction system, 2, 2A . . . multi-way speaker unit (an example of a plurality of speakers), 3, 3A . . . controller, 10 . . . listening space, 11 . . . listener, 20 . . . center speaker, 41 . . . left recording signal, 42 . . . right recording signal, LW . . . plurality of left speakers, RW . . . plurality of right speakers.

1. A sound reproduction system for reproducing sound in a listening space in which a listener is present, comprising:
a plurality of speakers disposed in the listening space; and
a controller configured to reproduce, based on a left recording signal corresponding to a left ear of the listener and a right recording signal corresponding to a right ear of the listener, three channels of sound including a center channel, a left channel, and a right channel from the plurality of speakers,
wherein the plurality of speakers comprises a center speaker corresponding to the center channel, a plurality of left speakers corresponding to the left channel, and a plurality of right speakers corresponding to the right channel,
each of the plurality of left speakers and each of the plurality of right speakers having a bandwidth set in advance so that each can output sound in a different bandwidth,
the controller comprises:
an inversion unit configured to invert a polarity of either one of (i) an input signal for the left speakers based on the left recording signal or (ii) an input signal for the right speakers based on the left recording signal, so that a phase difference between them is 180 degrees for all frequencies, and to invert the polarity of either one of (i) the input signal for the right speakers based on the right recording signal or (ii) the input signal for the left speakers based on the right recording signal, so that a phase difference between them is 180 degrees for all frequencies; and
a splitting unit configured to split the left recording signal and the right recording signal so as to form signals having discrete bandwidths,
wherein the controller causes the center speaker and the right and left speakers to which corresponding bandwidths are set to reproduce the sound corresponding to the signals having the discrete bandwidths, and
either the plurality of speakers or the controller includes delay means for delaying, for each of the left speakers and each of the right speakers, the sound corresponding to the signals having the discrete bandwidths by a relative delay time set in advance for each left speaker and each right speaker with respect to the center speaker,
the delay time being set in advance for each left speaker and each right speaker so that crosstalk at a predetermined frequency included in the bandwidth assigned to each left speaker and each right speaker is canceled.

2. The sound reproduction system according to claim 1, wherein the delay time is set in advance for each left speaker and each right speaker so that, at the predetermined frequency, a phase difference between the sound of the left channel and the sound of the center channel is shifted by 90 degrees, and a phase difference between the sound of the center channel and the sound of the right channel is shifted by 90 degrees.

3. The sound reproduction system according to claim 2, wherein the delay means provided in the controller is a delay unit configured to delay the signals having the discrete bandwidths by signal processing.

4. The sound reproduction system according to claim 3, wherein the delay time Δτ is determined in advance for each left speaker and each right speaker such that, in a coordinate system taking as an origin a center point of both ears of the listener as viewed in plan, letting θ be an angle formed by a line connecting a position of the right speaker or the left speaker and the origin and a line connecting a position of the center speaker and the origin, Δr be an equivalent distance between the ears, and c be speed of sound, the following relation holds: Δτ=(Δr·sin θ)/(2·c).

5. The sound reproduction system according to claim 2, wherein the delay means included in the plurality of speakers is realized by arranging the center speaker, the plurality of right speakers, and the plurality of left speakers so as to satisfy a positional relationship in which sound corresponding to the signals having the discrete bandwidths and arriving at the listener is delayed, for each right speaker and each left speaker, by the delay time set in advance for respective speaker.

6. The sound reproduction system according to claim 5, wherein arrangement positions of each speaker are determined such that, in a coordinate system taking as an origin a center point of both ears of the listener as viewed in plan, letting 9 be an angle formed by a line connecting the arrangement position of the right speaker or the left speaker and the origin and a line connecting the arrangement position of the center speaker and the origin, Δr be an equivalent distance between the ears, c be speed of sound, and Δl be a path difference between the right speaker or the left speaker and the center speaker, the following relation holds: Δl=(Δr·sin θ)/2.
